(19) United States
(12) Patent Application Publication
(10) Pub. No.: US 2019/0188614 A1
(43) Pub. Date: Jun. 20, 2019

(54) DEVIATION ANALYTICS IN RISK RATING SYSTEMS

(71) Applicant: Promontory Financial Group LLC, Washington, DC (US)

(72) Inventors: Daniel J. Ferranti, Washington, DC (US); Andrew S.H. Ting, Washington, DC (US)

(21) Appl. No.: 15/841,690

(22) Filed: Dec. 14, 2017

(51) Int. Cl. G06Q 10/06; G06Q 30/02

(52) U.S. Cl. CPC G06Q 10/0635; G06Q 40/12; G06Q 30/0205

(57) ABSTRACT

A set of operational risk rating algorithms is received. A set of operational risk rating weight factors is applied to the set of operational risk rating algorithms. An initial operational risk rating score of an entity associated with the selected domain category is generated based on the set of operational risk rating algorithms applied with the set of operational risk rating weight factors. A baseline operational risk rating score is retrieved based on the selected domain category. A deviation value is determined based on comparing the retrieved baseline operational risk rating score and the initial operational risk rating score.

### TECHNICAL FIELD

The present invention relates generally to a method, system, and computer program product for analytics systems. More particularly, the present invention relates to a method, system, and computer program product for deviation analytics for regulatory risk rating systems.

### BACKGROUND

Today, organizations around the world are constantly expanding their operations to other geographic regions, often pursing opportunities in new countries. Due to the increase of cross-border transactions and international business arrangements, the organizations are now conducting corporate activities on a global scale, such as launching new products and services in unfamiliar geographic regions. In response, several national governments and international governments established various regulations to govern the organizations' behavior and activities to ensure that the cross-border transactions are legal and ultimate benefit the society.

As such, the organizations need to comply with the rules and regulations as required by several national and international governing bodies. Failure to follow the rules and regulations often leads to corrective and regulatory actions by the governing bodies, which adversely affect the organizations to continue engaging in new business activities. In other words, any disruption to potentially profitable organizational activities, the disruption caused by a regulatory action, can derail an organization's confidence in further expanding its operations to unknown geographic regions. Thus, organizations routinely evaluate any operational risk involved in expanding their operations into new geographic regions.

### SUMMARY OF THE INVENTION

The illustrative embodiments provide a method, system, and computer program product. An aspect of the present invention retrieves a set of operational risk rating algorithms. The aspect of the present invention applies a set of operational risk rating weight factors to the set of operational risk rating algorithms. The aspect of the present invention generates an initial operational risk rating score of an entity associated with the selected domain category based on the set of operational risk rating algorithms applied with the set of operational risk rating weight factors. The aspect of the present invention retrieves a baseline operational risk rating score based on the selected domain category. The aspect of the present invention determines a deviation value based on comparing the retrieved baseline operational risk rating score and the initial operational risk rating score.

An aspect of the present invention includes a computer program product. The computer program product includes one or more computer-readable storage devices, and program instructions stored on at least one of the one or more storage devices.

An aspect of the present invention includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example system for deviation analytics in risk rating systems in accordance with an illustrative embodiment; and

FIG. 4 depicts a flowchart of an example process for deviation analytics in risk rating systems in accordance with an illustrative embodiment.

### DETAILED DESCRIPTION OF THE EMBODIMENTS

Illustrative embodiments recognize that several business organizations continue to increase their global presence by offering their products and services to newer countries, in an effort to potentially generate more revenue. Although expanding into new geographic regions or countries may present plenty of opportunities, organizations often struggle to navigate through laws and regulations in such geographic regions which may be enforced differently from the existing countries in which the organizations already operate.

For example, consider an organization venturing into a new geographic region to provide its new cryptocurrency transaction services. In the United States, there are only a few laws and regulations that govern the use of cryptocurrency such as Bitcoin, other than tax reporting requirements for gains and losses through cryptocurrency transactions. The new geographic region, however, includes several regulations that require cryptocurrency transactions above a certain amount to be reported to its securities regulatory agency. Unbeknownst to the organization, the new cryptocurrency transaction services without the rigorous reporting mechanisms may prompt the new geographic region's government authorities to sanction the organization under the anti-money laundering (AML) regulations. Accordingly, it can be assumed that the risk of violating AML regulations when dealing with cryptocurrency can be significantly higher in the new geographic region as compared to the United States.

Illustrative embodiments recognize that there are existing solutions that assist an organization to understand the risks involved in conducting business activities in certain geographic regions and/or countries based on the regulations, sanctions, and other types of regulatory actions established by national and international governing bodies. For example, the existing systems may evaluate the risk of sanctions of an organization conducting business in a specific country, based on the AML programs administered by Office of Foreign Assets Control (OFAC) of the U.S. Department of Treasury and the at-risk jurisdictions identified by the Financial Crimes Enforcement Network (FinCEN). In addition, illustrative embodiments recognize that the existing systems provide a set of ratings which provides the extent of the risk exposed to the organization should it provide its products and services in a geographic region, ranging from low, medium, and high risk.

Illustrative embodiments recognize that that the same sets of AML regulations typically apply to many organizations that are within the same industry. This is because organizations within the same industry typically offer similar products and services as well as conduct similar business activities. In some cases, the AML regulations may apply differently between organizations within the same industry based on the size of the organizations and volume of transactions. In effect, illustrative embodiments recognize that the AML risk rating systems analyzes similar sets of AML data and generates risk ratings that may be similar across several organizations within the same industry.

Illustrative embodiments recognize that the AML risk rating systems include a set of algorithms which may analyze the AML regulations and the subject organization in order to compute the risk ratings, and such set of algorithms or values resulting from those algorithms may be configured or customized by users within the organizations to more accurately evaluate the risk rating in context of these organizations. AML risk ratings may provide default scores through the set of algorithms and the configurations of the set of algorithms may include a weighted scoring system in which the numerical input to each AML or sanctions related category factors in the risk rating systems can be manually entered or customized. However, illustrative embodiments recognize that it is difficult to identify as to whether these customizations to the AML risk rating systems will be consistent with the accepted system standards of other organizations that belong to the same industry. Indeed, extreme customizations or configurations of AML risk rating systems may result in the risk ratings being inaccurate which in turn may expose the organizations to AML regulations or even sanctions.

The illustrative embodiments recognize that the presently available tools or solutions do not address the needs or provide adequate solutions for these needs. The illustrative embodiments used to describe the invention generally address and solve the above-described problems and other problems related to deviation analytics for risk rating systems.

An embodiment can be implemented as a software application. The application implementing an embodiment can be configured as a modification of an existing software platform, as a separate application that operates in conjunction with an existing software platform, a standalone application, or some combinations thereof.

In one embodiment, the system can determine the extent of deviation of the updated AML risk rating system to other risk rating systems that are categorized within the same industry. In some embodiments, the deviation analysis can be triggered in response to a user changing a weighting system of the AML risk rating system. In other embodiments, the deviation analysis can be triggered in response to a user changing the set of algorithms or a methodology through with the AML risk rating is calculated. If the system determines that the deviation exceeds a threshold value, the embodiment of the present invention issues an alert to the user that the configurations of the AML risk rating system deviates from the other risk rating systems being used in the same industry.

In one embodiment, the system identifies at least one industry associated with the organization. In one embodiment, the system accepts the changes to the weighting system or algorithms of the AML risk rating system from the user and calculates the risk score resulting from the changes. In one embodiment, the system ingests and aggregates risk rating values generated from a plurality of AML risk rating systems within the same industry category. The aggregated data is leveraged to form a baseline risk rating. Afterwards, the system determines the level of deviation of the risk rating generated by the customizations from the determined baseline risk rating of the industry category.

The illustrative embodiments are described with respect to certain types of analytic systems, algorithms, risk ratings, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

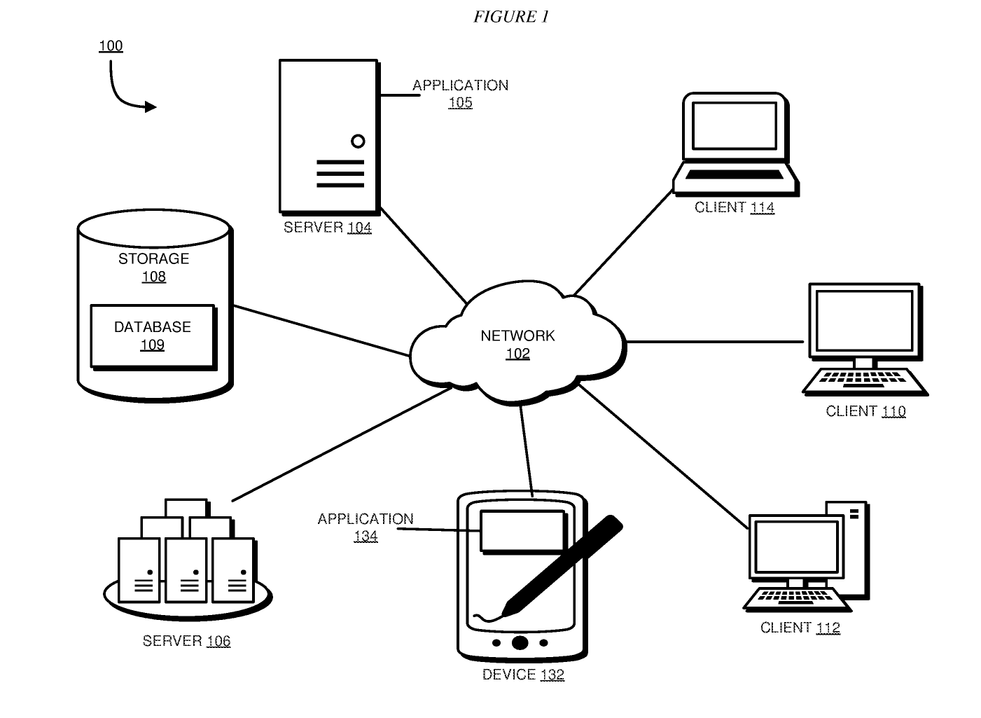

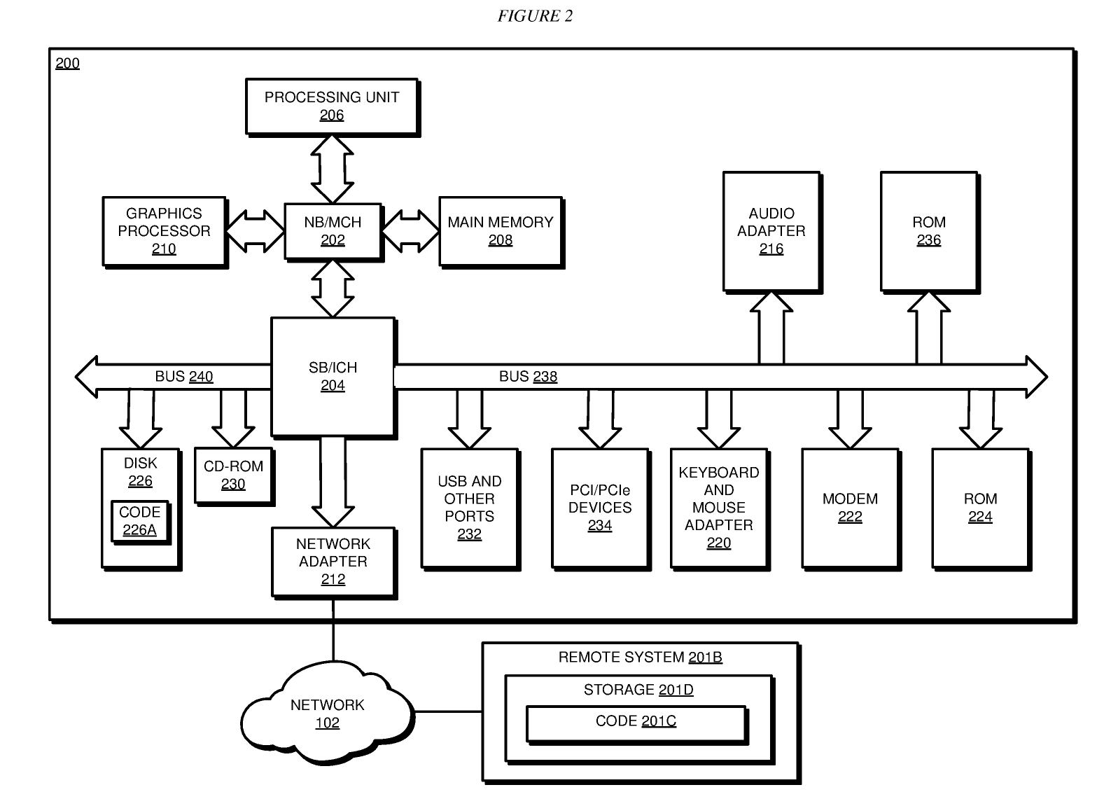

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 alone, application 134 alone, or applications 105 and 134 in combination implement an embodiment described herein. Channel data source 107 provides the past period data of the target channel or other channels in a manner described herein.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 and/or application 134 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

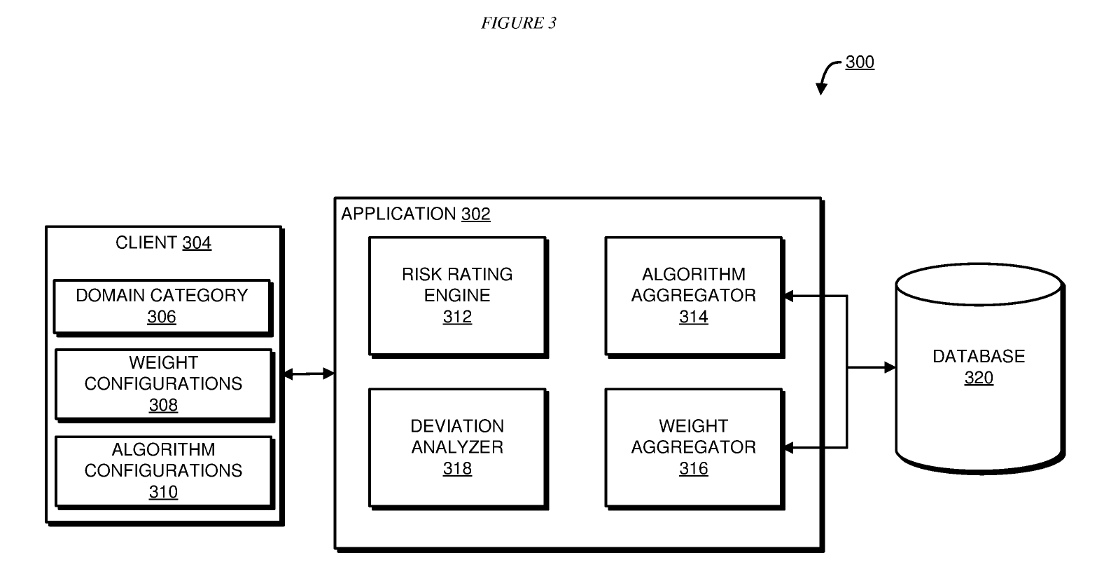

With reference to FIG. 3, this figure depicts a block diagram of an example system for deviation analytics in risk rating systems in accordance with an illustrative embodiment. Application 302 is an example of application 105 in FIG. 1. Client 304 is an example of clients 110, 112, and 114 in FIG. 1.

Application 302 receives input from client 304, including domain category 306, weight configurations 308, and algorithm configurations 310. In one embodiment, domain category 306 includes a type of business industry in which an entity is engaged. For example, domain category 306 may include banking, technology, energy, and retail. In other embodiments, domain category 306 may include a type of operations conducted by an entity. In this example, domain category 306 may include broker and dealer activities, trading, manufacturing, and distribution. In one embodiment, domain category 306 may be limited to geographic regions in which an entity conducts its operations. In several embodiments, domain category 306 selected by a user can be used by application 302 to construct a database query to retrieve a plurality of algorithms and weight factors that are relevant to domain category 306.

Weight configurations 308 may include a set of risk rating weight factors to be used for risk rating systems. In one embodiment, a user may adjust default risk rating weight factors affect the overall risk rating score generated by application 302. Algorithm configurations 310 may include a set of algorithms used to determine the risk rating scores for an entity. In one embodiment, a user may adjust default set of algorithms that affects the overall risk rating score generated by application 302. In some embodiments, algorithm configurations 310 can be adjusted by removing, adding, or otherwise updating a set of variables used to compute the risk rating score. In other embodiments, algorithm configurations 310 can be adjusted by adding, removing, or otherwise updating the functions and/or statements embedded into the set of algorithms. In several embodiments, risk rating weight factors are applied to the functions of the set of algorithms to generate the overall risk rating score of an entity.

In one embodiment, initial risk rating factor values designated in weight configurations 308 and algorithm configurations 310 may be initially determined as a function of the selection of domain category 306 by the user. For example, a first set of weight factors can be initially determined based on a banking category, while a different set of weight factors can be initially determined based on an energy category. In this example, both sets of weight factors can be subsequently adjusted by a user and submitted into application 302 as weight configurations 308.

Application 302 includes risk rating engine 312, algorithm aggregator 314, weight aggregator 316, and deviation analyzer 318. Risk rating engine 312 receives domain category 306, weight configurations 308, and algorithm configurations 310 to determine an initial risk rating score of an entity. In one embodiment, risk rating engine 312 may adjust the initial risk rating score based on the values received weight configurations 308 and algorithm configurations 310 and further based on the received domain category 306. In some embodiments, the initial risk rating score may be provided back to client 304. In response to the user reviewing the initial risk rating score and further customizing values in weight configurations 308 and algorithm configurations 310, risk rating engine 312 dynamically updates the initial risk rating score based a subsequent input from client 304.

Algorithm aggregator 314 receives and aggregates a set of algorithms retrieved from database 320. In one embodiment, algorithm aggregator 314 constructs and executes a database query based on domain category 306. For example, a SQL database query based on “Technology” category may be constructed as SELECT algorithms FROM risk_rating WHERE domain=‘Technology’. In one embodiment, algorithm aggregator 314 receives the query results from the constructed database query then executes the algorithms retrieved in the query results. In this embodiment, algorithm aggregator 314 obtains intermediate values generated by executing the retrieved algorithms associated with domain category 306, then calculates a baseline algorithm score from the generated intermediate values. In one embodiment, the baseline algorithm score may be an average of the generated intermediate values. In another embodiment, the baseline algorithm score may be a median of the generated intermediate values. In both embodiments, baseline algorithm score may be provided to deviation analyzer 318 and/or applied to baseline weight factors obtained from weight aggregator 316 to calculate a baseline risk rating.

Weight aggregator 316 receives and aggregates a set of weight factors retrieved from database 320. In one embodiment, weight aggregator 316 constructs and executes a database query based on domain category 306. For example, a SQL database query based on “Trading” category that is based on U.S. activities may be constructed as SELECT weight1, weight2, weight3 FROM risk_rating WHERE domain=‘Trading’ AND region=‘USA’. In one embodiment, weight aggregator 316 receives the query results from executing the constructed database query then obtains a set of weight factors retrieved in the query results. In one embodiment, weight aggregator 316 calculates baseline weight factors from the obtained set of weight factor values. In one embodiment, the baseline weight factors may be an average of the obtained weight factor values. In another embodiment, the baseline weight factors may be a median of the obtained weight factor values. In both embodiments, baseline weight factors may be provided to deviation analyzer 318 and/or applied to baseline algorithm score obtained from algorithm aggregator 314 to calculate the baseline risk rating.

Deviation analyzer 318 receives the baseline algorithm score generated by algorithm aggregator 314, baseline weight factors generated by weight aggregator 316, and the baseline risk rating calculated as a function of the baseline algorithm score and baseline weight factors. Deviation analyzer 318 additionally receives the initial risk rating score calculated by risk rating engine 312, weight configurations 308, and intermediate values generated from executing the set of algorithms inputted via algorithm configurations 310. In one embodiment, deviation analyzer 318 compares the baseline values (e.g., baseline risk rating) with the corresponding input values (e.g., initial risk rating score) provided by client 304, and determines the deviation between the values. In some embodiments, deviation analyzer 318 may include a threshold value against which the deviation values are compared. In response to the deviation values exceeding the threshold, deviation analyzer issues an alert to client 304 that weight configurations 308 and algorithm configurations 310 are not standard values for domain category 306. In other embodiments, deviation analyzer 318 may convert the deviation value into a percentage value and provides to client 304 as to how much percent the data (and adjustments thereof) from weight configurations 308 and algorithm configurations 310 deviates from the deviation value.

Database 320 may be implemented through a relational database in which the records are organized into a tabular format, having rows and columns in which the corresponding information can be stored in a “structured” format. Examples of a relational database include SQL and IBM® DB2®. The records stored in a relational database can be retrieved by executing a query constructed through user input.

In other embodiments, database 320 may be a non-relational database such as NoSQL. A NoSQL database environment is a non-relational and largely distributed database system that enables rapid, ad-hoc organization and analysis of extremely high-volume, disparate data types. NoSQL databases are sometimes referred to as cloud databases, non-relational databases, Big Data databases and a myriad of other terms and were developed in response to the sheer volume of data being generated, stored and analyzed by modern users (user-generated data) and their applications (machine-generated data).

In general, NoSQL databases have become the first alternative to relational databases, with scalability, availability, and fault tolerance being key deciding factors. They go well beyond the more widely understood legacy, relational databases (such as Oracle, SQL Server, and DB2 databases) in satisfying the needs of today's modern business applications. A very flexible and schema-less data model, horizontal scalability, distributed architectures, and the use of languages and interfaces that are “not only” SQL typically characterize this technology. Contrary to misconceptions caused by its name, NoSQL does not prohibit structured query language (SQL). While it's true that some NoSQL systems are entirely non-relational, others simply avoid selected relational functionality such as fixed table schemas and join operations. For example, instead of using tables, a NoSQL database might organize data into objects, key/value pairs or tuples.

There are four general types of NoSQL databases, each with their own specific attributes:

Graph database—Based on graph theory, these databases are designed for data whose relations are well represented as a graph and has elements which are interconnected, with an undetermined number of relations between them. Examples include Neo4j and Titan.

Key-Value store—we start with this type of database because these are some of the least complex NoSQL options. These databases are designed for storing data in a schema-less way. In a key-value store, all of the data within consists of an indexed key and a value, hence the name. Examples of this type of database include Cassandra, DyanmoDB, Azure Table Storage (ATS), Riak, BerkeleyDB.

Column store—(also known as wide-column stores) instead of storing data in rows, these databases are designed for storing data tables as sections of columns of data, rather than as rows of data. While this simple description sounds like the inverse of a standard database, wide-column stores offer very high performance and a highly scalable architecture. Examples include HBase, BigTable, and HyperTable.

Document database—expands on the basic idea of key-value stores where “documents” contain more complex in that they contain data and each document is assigned a unique key, which is used to retrieve the document. These are designed for storing, retrieving, and managing document-oriented information, also known as semi-structured data. Examples include MongoDB and CouchDB.

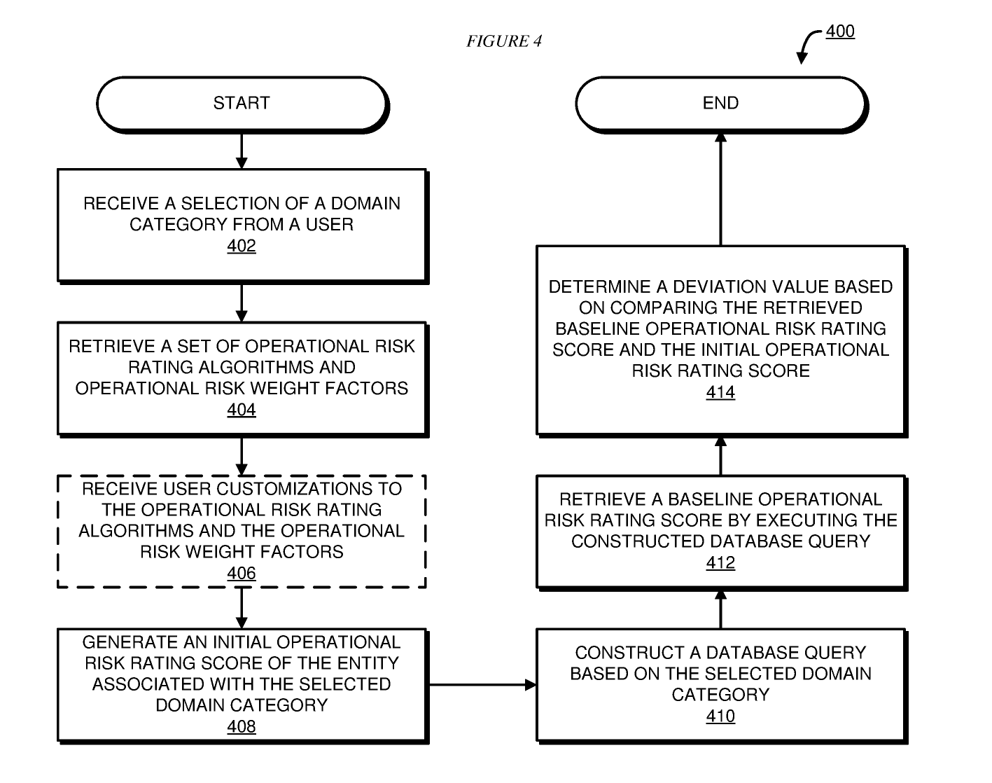

With reference to FIG. 4, this figure depicts a flowchart of an example process for deviation analytics in risk rating systems in accordance with an illustrative embodiment. Process 400 may be implemented in application 302 in FIG. 3.

The application receives a selection of a domain category from a user (block 402). In one embodiment, the domain category may include a type of industry associated with an entity. In another embodiment, the domain category may include a type of operations conducted by the entity. The application retrieves a set of operational risk rating algorithms and operational risk weight factors (block 404). In one embodiment, the default values of the set of operational risk rating algorithms and operational risk rating weight factors are assigned based on the selected domain category. As an optional step, the application receives user customizations to the operational risk rating algorithms and the operational risk weight factors (block 406).

Based on the set of operational risk rating algorithms and operational risk weight factors, the application generates an initial operational risk rating score of the entity associated with the selected domain category (block 408). The application constructs a database query based on the selected domain category (block 410). The application retrieves a baseline operational risk rating score by executing the constructed database query (block 412).

The application determines a deviation value based on comparing the retrieved baseline operational risk rating score and the initial operational risk rating score (block 414). In one embodiment, the application may issue an alert to a client device (e.g., client 304) in response to the determined deviation value exceeding a predetermined threshold value. Process 400 terminates thereafter.

Thus, a computer implemented method, system or apparatus, and computer program product are provided in the illustrative embodiments for merging two documents that may contain different perspectives and/or bias. Where an embodiment or a portion thereof is described with respect to a type of device, the computer implemented method, system or apparatus, the computer program product, or a portion thereof, are adapted or configured for use with a suitable and comparable manifestation of that type of device.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of performing deviation analytics in risk rating systems comprising:
retrieving a set of operational risk rating algorithms;
applying a set of operational risk rating weight factors to the set of operational risk rating algorithms;
generating an initial operational risk rating score of an entity associated with the selected domain category based on the set of operational risk rating algorithms applied with the set of operational risk rating weight factors;
retrieving a baseline operational risk rating score based on the selected domain category; and
determining a deviation value based on comparing the retrieved baseline operational risk rating score and the initial operational risk rating score.

2. The method according to claim 1, further comprising:
issuing an alert to a client device in response to the determined deviation value exceeding a predetermined threshold value.

3. The method according to claim 1, wherein:
default values of the set of operational risk rating algorithms and default values of the set of operational risk rating weight factors are assigned based on a selected domain category; and
the default values of the set of operational risk rating algorithms and the set of operational risk rating weight factors can be configured by user input.

4. The method according to claim 3, further comprising:
adjusting the initial operational risk rating score to generate a customized risk rating score, wherein the step of adjusting is based on user configurations to the set of operational risk rating algorithms and the set of operational risk rating weight factors;
determining an adjusted deviation value based on comparing the baseline operational risk rating score and the customized risk rating score; and
issuing an alert to a client device in response to the adjusted deviation value exceeding a predetermined threshold value.

5. The method according to claim 4, wherein:
the selected domain category includes a type of operational activities performed by the entity; and
the alert includes a notification indicative of the customized risk rating score not being an accepted standard value of the selected domain category.

6. The method according to claim 1, wherein the step of retrieving a baseline operational risk rating score based on the selected domain category further comprises:
constructing a database query based on the selected domain category;
aggregating a plurality of values retrieved by processing the database query; and
calculating the baseline operational risk rating score based on the retrieved plurality of baseline algorithms and weight factors.

7. The method according to claim 6, wherein the aggregated plurality of values include baseline algorithms and weight factors associated with the selected domain category.

8. A computer program product for performing deviation analytics in risk rating systems, the computer program product comprising one or more computer readable storage medium and program instructions stored on at least one of the one or more computer readable storage medium, the program instructions comprising:
program instructions to retrieve a set of operational risk rating algorithms;
program instructions to apply a set of operational risk rating weight factors to the set of operational risk rating algorithms;
program instructions to generate an initial operational risk rating score of an entity associated with the selected domain category based on the set of operational risk rating algorithms applied with the set of operational risk rating weight factors;
program instructions to retrieve a baseline operational risk rating score based on the selected domain category; and
program instructions to determine a deviation value based on comparing the retrieved baseline operational risk rating score and the initial operational risk rating score.

9. The computer program product according to claim 8, further comprising:
program instructions to issue an alert to a client device in response to the determined deviation value exceeding a predetermined threshold value.

10. The computer program product according to claim 8, wherein:
default values of the set of operational risk rating algorithms and default values of the set of operational risk rating weight factors are assigned based on a selected domain category; and
the default values of the set of operational risk rating algorithms and the set of operational risk rating weight factors can be configured by user input.

11. The computer program product according to claim 10, further comprising:
program instructions to adjust the initial operational risk rating score to generate a customized risk rating score, wherein the step of adjusting is based on user configurations to the set of operational risk rating algorithms and the set of operational risk rating weight factors;
program instructions to determine an adjusted deviation value based on comparing the baseline operational risk rating score and the customized risk rating score; and
program instructions to issue an alert to a client device in response to the adjusted deviation value exceeding a predetermined threshold value.

12. The computer program product according to claim 11, wherein:
the selected domain category includes a type of operational activities performed by the entity; and
the alert includes a notification indicative of the customized risk rating score not being an accepted standard value of the selected domain category.

13. The computer program product according to claim 8, wherein program instructions to retrieve a baseline operational risk rating score based on the selected domain category further comprises:
program instructions to construct a database query based on the selected domain category;
program instructions to aggregate a plurality of values retrieved by processing the database query; and
program instructions to calculate the baseline operational risk rating score based on the retrieved plurality of baseline algorithms and weight factors.

14. The computer program product according to claim 13, wherein the aggregated plurality of values include baseline algorithms and weight factors associated with the selected domain category.

15. A computer system for performing deviation analytics in risk rating systems, the computer system comprising one or more processors, one or more computer readable memories, one or more computer readable storage medium, and program instructions stored on at least one of the one or more storage medium for execution by at least one of the one or more processors via at least one of the one or more memories, the program instructions comprising:
program instructions to retrieve a set of operational risk rating algorithms;
program instructions to apply a set of operational risk rating weight factors to the set of operational risk rating algorithms;
program instructions to generate an initial operational risk rating score of an entity associated with the selected domain category based on the set of operational risk rating algorithms applied with the set of operational risk rating weight factors;
program instructions to retrieve a baseline operational risk rating score based on the selected domain category; and
program instructions to determine a deviation value based on comparing the retrieved baseline operational risk rating score and the initial operational risk rating score.

16. The computer system according to claim 15, further comprising:
program instructions to issue an alert to a client device in response to the determined deviation value exceeding a predetermined threshold value.

17. The computer system according to claim 15, wherein:
default values of the set of operational risk rating algorithms and default values of the set of operational risk rating weight factors are assigned based on a selected domain category; and
the default values of the set of operational risk rating algorithms and the set of operational risk rating weight factors can be configured by user input.

18. The computer system according to claim 17, further comprising:
program instructions to adjust the initial operational risk rating score to generate a customized risk rating score, wherein the step of adjusting is based on user configurations to the set of operational risk rating algorithms and the set of operational risk rating weight factors;
program instructions to determine an adjusted deviation value based on comparing the baseline operational risk rating score and the customized risk rating score; and
program instructions to issue an alert to a client device in response to the adjusted deviation value exceeding a predetermined threshold value.

19. The computer system according to claim 18, wherein:
the selected domain category includes a type of operational activities performed by the entity; and
the alert includes a notification indicative of the customized risk rating score not being an accepted standard value of the selected domain category.

20. The computer system according to claim 15, wherein program instructions to retrieve a baseline operational risk rating score based on the selected domain category further comprises:
program instructions to construct a database query based on the selected domain category;
program instructions to aggregate a plurality of values retrieved by processing the database query; and
program instructions to calculate the baseline operational risk rating score based on the retrieved plurality of baseline algorithms and weight factors.
